(19) United States
(12) Patent Application Publication
(10) Pub. No.: US 2014/0184507 A1
(43) Pub. Date: Jul. 3, 2014

(54) DISPLAY DEVICE AND DISPLAY CONTROL SYSTEM

(71) Applicant: PANASONIC CORPORATION, Osaka (JP)

(72) Inventors: Kazuhiro YAMADA, Osaka (JP); Yasuhiro TANAKA, Hyogo (JP); Isao SHIMADA, Hyogo (JP); Takeshi TANAKA, Hyogo (JP); Masahiro ISHII, Hyogo (JP)

(73) Assignee: PANASONIC CORPORATION, Osaka (JP)

(21) Appl. No.: 14/198,219

(22) Filed: Mar. 5, 2014

Related U.S. Application Data
(63) Continuation of application No. PCT/JP2012/005618, filed on Sep. 5, 2012.

(30) Foreign Application Priority Data
Sep. 6, 2011 (JP) 2011-193644

(51) Int. Cl. G06F 3/03

(52) U.S. Cl. CPC G06F 3/0304
USPC 345/158

(57) ABSTRACT

A display control system includes a display device including a display area in which a plurality of pixels is provided and which displays an image and a pointer device configured to indicate a location on the display area. A locational information pattern indicating the ln on the display area is provided on the display area. The locational information pattern is made of a plurality of marks which is provided in the sub pixels and absorbs or reflects light. The pointer device is configured to optically read the locational information pattern in a location indicated on the display area. The display device controls the display area such that display contents in a location corresponding to the locational information pattern read by the pointer device.

### CROSS-REFERENCE TO RELATED APPLICATION

This is a continuation of International Application No. PCT/JP2012/005618 filed on Sep. 5, 2012, which claims priority to Japanese Patent Application No. 2011-193644 filed on Sep. 6, 2011. The entire disclosures of these applications are incorporated by reference herein.

### BACKGROUND

The present disclosure relates to display control systems enabling handwriting input on display surfaces of digital displays and display devices used therefore.

Japanese Patent Publication No. 2007-226577 describes a technique in which characters, etc. are written on a piece of paper with a pen, the information written on the paper is computerized, and the computerized information is sent to a server and/or a terminal.

### SUMMARY

The present disclosure provides a display control system enabling handwriting input on a display surface of a digital display in a high definition manner and a display device used therefore.

A display control system according to the present disclosure includes a display device including a display area in which a plurality of pixels is provided and which displays an image and a pointer device configured to indicate a location on the display area, and performs display control in accordance with a location indicated by the display device. In the display control system, each of the pixels includes a red sub pixel, a green sub pixel, and a blue sub pixel, a locational information pattern indicating the location on the display area is provided on the display area, the locational information pattern is made of a plurality of marks which is provided in the sub pixels and absorbs or reflects light, the pointer device includes an optical source configured to output light and a reader configured to receive light output from the optical source and reflected by the display area and thereby read the locational information pattern and is configured to optically read the locational information pattern in a location indicated on the display area, and the display device controls the display area such that display contents in a location corresponding to the locational information pattern read by the pointer device is changed. Each of the pixels includes a red sub pixel, a green sub pixel, and a blue sub pixel. The locational information pattern is made of a plurality of marks which is provided in the sub pixels and absorbs or reflects light. The pointer device includes an optical source configured to output light and a reader configured to receive light output from the optical source and reflected by the display area and thereby read the locational information pattern.

A display device according to the present disclosure includes a display device including a display area in which a plurality of pixels is provided and which displays an image. In the display device, each of the pixels includes a red sub pixel, a green sub pixel, and a blue sub pixel, a locational information pattern which is configured to be optically readable from outside and indicates a location on the display area is provided on the display area, and the locational information pattern is made of a plurality of marks which is provided in the sub pixels and absorbs or reflects light. Each of the pixels includes a red sub pixel, a green sub pixel, and a blue sub pixel. The locational information pattern is made of a plurality of marks which is provided in the sub pixels and absorbs or reflects light.

The display control system according to the present disclosure may enable high definition handwriting input.

The display device according to the present disclosure may enable high definition handwriting input.

### BRIEF DESCRIPTION OF THE DRAWINGS

FIG. 1 is a schematic view of a display control system according to a first embodiment.

FIG. 2 is a block diagram of the display control system.

FIG. 3 is a schematic cross-sectional view of a display panel.

FIG. 4 is an enlarged view of a display area.

FIG. 5 is a schematic cross-sectional view of a digital pen.

FIG. 6 is a plan view of a color filter.

FIG. 7A is a view illustrating a location of a dot corresponding to the numerical reference “1”, FIG. 7B is a view illustrating a location of a dot corresponding to the numerical reference “2”, FIG. 7C is a view illustrating a location of a dot corresponding to the numerical reference “3,” and FIG. 7D is a view illustrating a location of a dot corresponding to the numerical reference “4.”

FIG. 8 is a flow chart illustrating a flow of processing performed by the display control system.

FIG. 9A is a plan view of a color filter having a dot pattern according to a first modified example, FIG. 9B is a plan view of a color filter having a dot pattern according to a second modified example, and FIG. 9C is a plan view of a color filter having a dot pattern according to a third modified example.

FIG. 10 is a schematic cross-sectional view of a digital pen according to a modified example.

FIG. 11 is a block diagram of a display control system according to a second embodiment.

FIG. 12 is a flow chart illustrating a flow of processing performed by the display control system.

### DETAILED DESCRIPTION

Embodiments will be described below in detail with reference to the accompanying drawings as appropriate. Note that detailed description more than necessary may be omitted. For example, the detail description of well-known matters and the redundant description of substantially the same configurations may be omitted. Such omission is made to avoid unnecessary redundancy in the following description and to help those skilled in the art easily understand the present disclosure.

Note that the present inventor(s) provides the attached drawings and the following description for those skilled in the art to fully understand the present disclosure and does not intend to limit the subject described in the claims by the attached drawings and the following description.

### First Embodiment

### 1. Outline of Display Control System

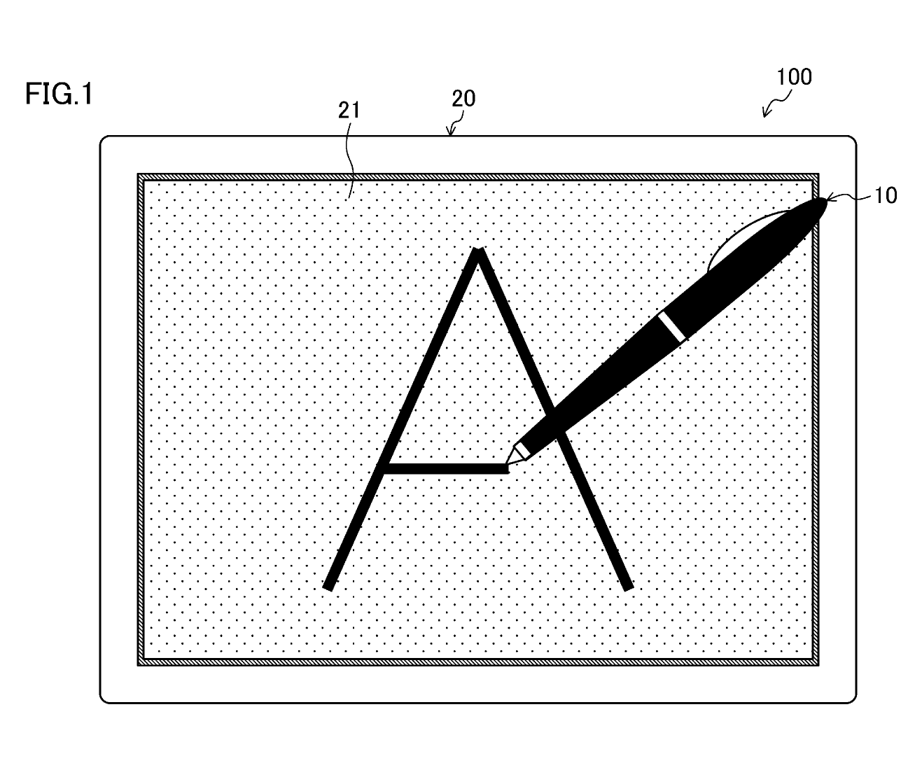

FIG. 1 is a view schematically illustrating an external appearance of a display control system 100 according to a first embodiment. The display control system 100 includes an optical digital pen (which will be hereinafter merely referred to as a “digital pen”) 10 and a display device 20. As will be described later in detail, the display device 20 is a liquid crystal display and displays various images on a display area 21. A dot pattern indicating a location on the display area 21 is provided to the display device 20. The digital pen 10 optically reads the dot pattern to detect information (which will be herein after also referred to as “locational information”) relating to the location of the digital pen 10 on the display area 21 and transmits the locational information to the display device 20. The display device 20 receives the locational information as an input and performs various display controls. For example, the display device 20 continuously displays dots on the display area 21 in accordance with a trace of the digital pen 10. Thus, characters and figures, etc. can be handwritten on the display area 21 using the digital pen 10. Alternatively, the display device 20 continuously erases dots on the display area 21 in accordance with a trace of the digital pen 10. Thus, characters and figures, etc. on the display area 21 can be erased using the digital pen 10 as an eraser. That is, the digital pen 10 functions as a readout device and also functions as an input device to the display control system 100. The digital pen 10 is an example of a pointer device.

### 2. Configuration of Display Device

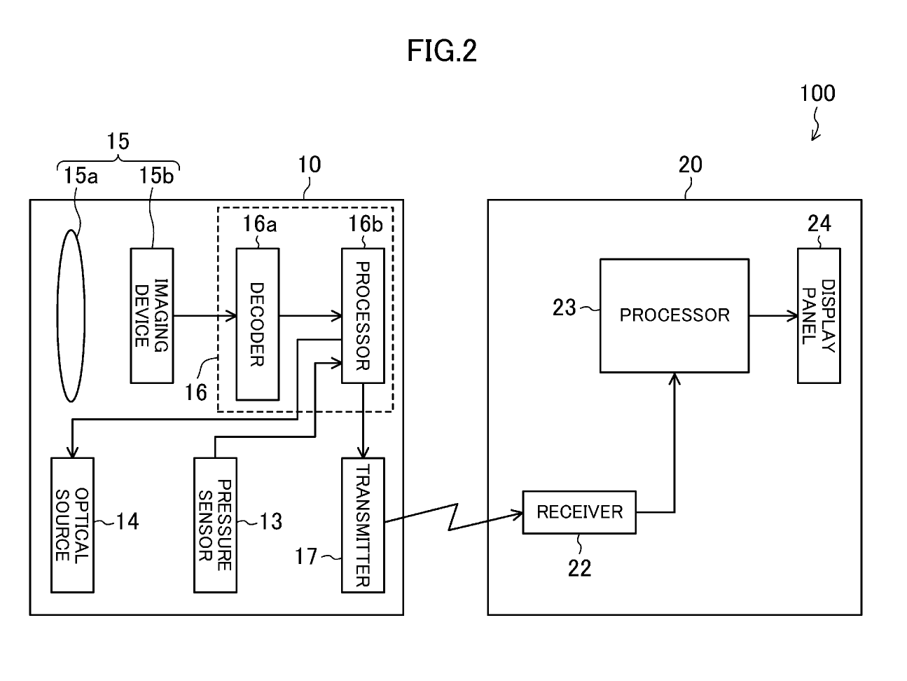

The display device 20 will be described below. FIG. 2 is a block diagram schematically illustrating a configuration of the display control system 100.

The display device 20 includes a receiver 22 configured to receive an external signal, a display processor 23 configured to control the entire display device 20, and a display panel 24 configured to display an image.

The receiver 22 receives a signal transmitted from the digital pen 10, which will be described later in detail. The signal received by the receiver 22 is transmitted to the display processor 23.

The display processor 23 includes a CPU and a memory, etc., and, a program used for operating a CPU is provided therein. For example, the display processor 23 controls the display panel 24, based on a signal transmitted from the digital pen 10, to change contents that the display processor 23 causes the display panel 24 to display.

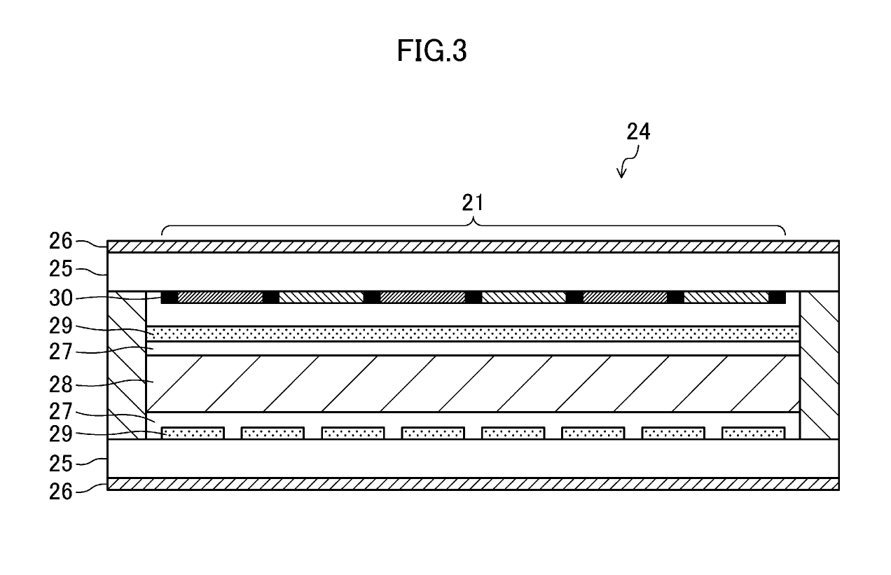

FIG. 3 is a schematic cross-sectional view of the display panel 24. The display panel 24 is a liquid crystal panel. A basic configuration of the display panel 24 is similar to a configuration of a typical liquid crystal panel. Specifically, the display panel 24 includes a pair of glass substrates 25, a polarizing filter 26 provided on an external surface of each of the glass substrates 25, a pair of oriented films 27 provided between the pair of glass substrates 25, a liquid crystal layer 28 provided between the pair of oriented films 27, a transparent electrode 29 provided on each of the oriented films 27, and a color filter 30 provided between the glass substrate 25 located closer to a surface of the display panel 24 and the transparent electrode 29. The display area 21 is formed on the surface of the display panel 24.

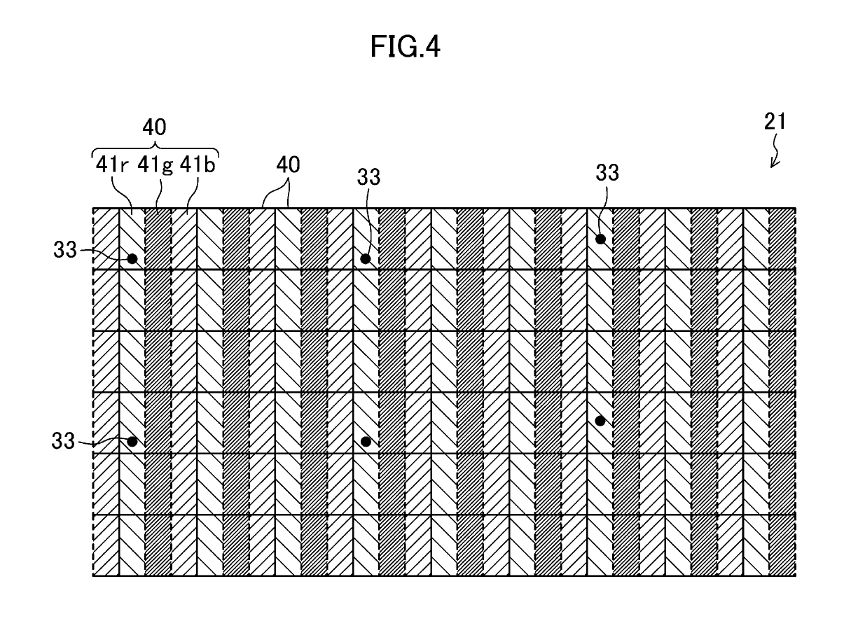

FIG. 4 is an enlarged view of the display area 21. A plurality of pixels 40 is provided in the display area 21. The plurality of pixels 40 is provided in matrix in the display area 21. Each of the pixels 40 includes a red sub pixel 41r, a green sub pixel 41g, and a blue sub pixel 41b. Note that, when the colors of the pixels are not distinguished, the term “sub pixel(s) 41” is simply used. Various images are displayed in the display area 21. As will be described later in detail, dots 33 are provided in the sub pixels 41. A group of the dots 33 forms a dot pattern. The dots 33 are an example of marks, and the dot pattern is an example of a locational information pattern.

### 3. Configuration of Digital Pen

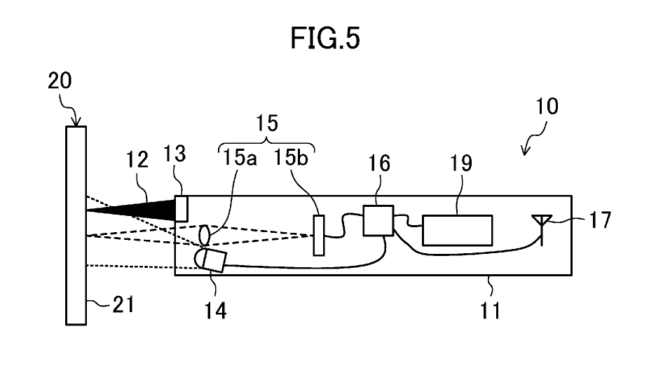

Next, a detail configuration of the digital pen 10 will be described. FIG. 5 is a cross-sectional view illustrating a schematic configuration of the digital pen 10.

The digital pen 10 includes a cylindrical body 11, a nib 12 attached to the tip of the body 11, a pressure sensor 13 configured to detect pressure applied to the nib 12, an optical source 14 configured to output infrared light, a reader 15 configured to read incident infrared light, a controller 16 configured to control the digital pen 10, a transmitter 17 configured to output a signal to the outside, and a power supply 19 configured to supply electric power to each member of the digital pen 10. The digital pen 10 has a pen shape.

The body 11 is made of a cylinder similar to a typical pen. The nib 12 has a tapered shape, and the tip of the nib 12 is rounded so that the surface of the display area 21 is not scratched. The nib 12 preferably has such a shape that a user easily recognizes an image displayed on the display area 21.

The pressure sensor 13 is built in the body 11, and is connected to a base end portion of the nib 12. The pressure sensor 13 detects pressure applied to the nib 12 and transmits the result of the detection to the controller 16. Specifically, the pressure sensor 13 detects pressure applied to the nib 12 when a user writes a character, etc. on the display area 21 using the digital pen 10. That is, the pressure sensor 13 is used to determine whether or not a user has intension to input a character, etc. using the digital pen 10.

The optical source 14 is provided at a tip portion of the body 11 near the nib 12. The optical source 14 includes, for example, an infrared LED, and is configured to output infrared light from the body 11.

The reader 15 is provided at the tip portion of the body 11 near the nib 12. The reader 15 includes an objective lens 15a and an imaging device 15b. The objective lens 15a forms an image on the imaging device 15b from incident light. Since the objective lens 15a is provided at the tip portion of the body 11, infrared light output from the optical source 14 and reflected on the display device 20 enters the objective lens 15a. The imaging device 15b is provided on the optical axis of the objective lens 15a. The imaging device 15b converts an optical image formed on its imaging plane to an electrical signal and outputs the electrical signal to the controller 16. The imaging device 15b includes, for example, a CCD image sensor or a CMOS image sensor. As described in detail later, the dot patterns are made of a material that absorbs infrared light, and thus, infrared light is not reflected at the dot patterns. As a result, an optical image in which the dot patterns appear black is captured by the imaging device 15b.

As illustrated in FIG. 2, the controller 16 includes a decoder 16a and a pen processor 16b. The decoder 16a determines the locational information of the digital pen 10 on the display area 21, based on an image signal transmitted from the reader 15. Specifically, the decoder 16a obtains a dot pattern from the image signal obtained by the reader 15 and identifies, based on the dot pattern, the location of the nib 12 on the display area 21. Information about the location of the nib 12 determined by the decoder 16a is sent to the pen processor 16b. The pen processor 16b controls the entire digital pen 10. The pen processor 16b includes a CPU and a memory, etc., and a program used for operating the CPU is also provided therein. The pen processor 16b is an example of a controller.

The transmitter 17 transmits a signal to the outside. Specifically, the transmitter 17 wirelessly transmits the locational information determined by the decoder 16a to the outside. The transmitter 17 performs near field wireless communication with the receiver 22 of the display device 20. The transmitter 17 is provided at an end portion of the body 11, which is opposite to the nib 12.

### 4. Detailed Configuration of Color Filter

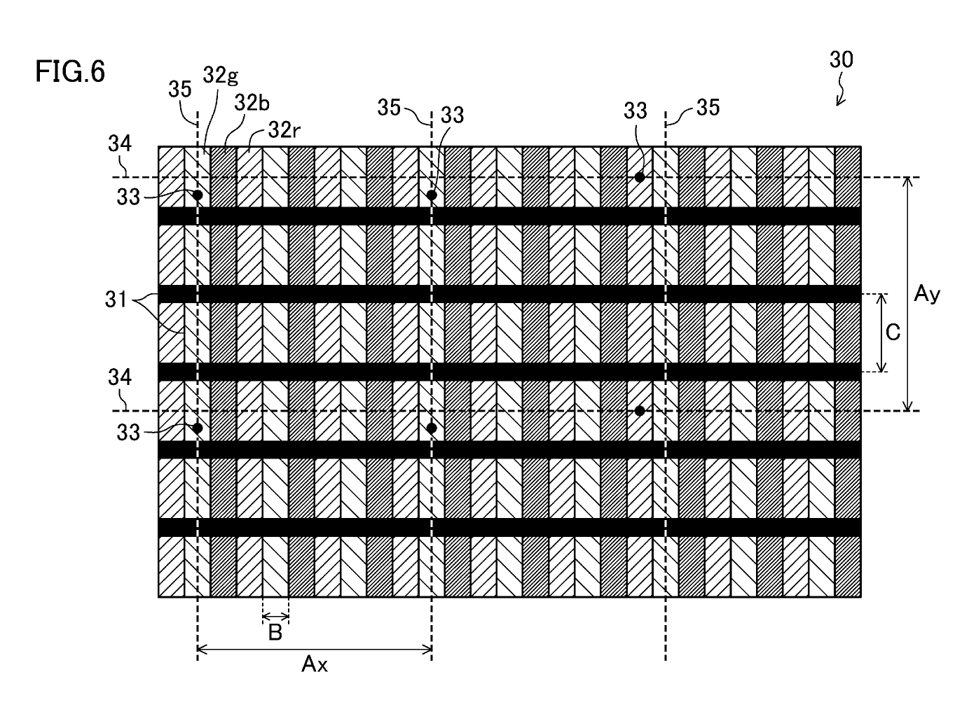

Subsequently, the detailed configuration of the color filter 30 will be described. FIG. 6 is a plan view of the color filter 30.

The color filter 30 includes a black matrix 31, pixel regions 32 which are defined by the black matrix 31 and are transmissive to light in certain colors, and dots 33 provided in the pixel regions 32. The pixel regions 32 include a red pixel region 32r transmissive to red (R) light, a green pixel region 32g transmissive to green (G) light, and a blue pixel region 32b transmissive to blue (B) light. Each of the pixel regions 32 has a rectangular shape. The pixel regions 32 correspond to the sub pixels 41 of the display area 21. Specifically, the red pixel region 32r corresponds to the red sub pixel 41r, the green pixel region 32g corresponds to the green sub pixel 41g, and the blue pixel region 32b corresponds to the blue sub pixel 41b. Note that, when the colors of light to be transmitted are not distinguished from one another, the term “pixel region(s) 32” is simply used. The pixel regions are an example of a colored layer.

The red pixel region 32r, the green pixel region 32g, and the blue pixel region 32b are located in this order in the lateral direction of the pixel region 32. In the longitudinal direction of the pixel region 32, the pixel regions 32 of the same color are located. That is, next to one red pixel region 32r in the longitudinal direction, another red pixel region 32r is located. Similarly, next to one green pixel region 32g in the longitudinal direction, another green pixel region 32g is located. Similar applies to the blue pixel region 32b. The black matrix 31 includes column lines extending in the longitudinal direction of the pixel region 32 and row lines extending in the lateral direction of the pixel region 32, and is formed in a lattice shape. The row lines are larger in width than the column lines. The black matrix 31 and the dots 33 are made of a material containing carbon black as a main component. The dots 33 are formed into a solid circular shape. The dots 33 are provided not in all of the pixel regions 32 but in some of the pixel regions 32. In the color filter 30, a group of the dots 33 forms a dot pattern. Dot patterns differ from one another depending on locations in the color filter 30.

The dot pattern will be described in detail below.

First, first reference lines 34 and second reference lines 35 are defined on color filter 30. These first and second reference lines 34 and 35 are virtual lines but do not exist in reality. The first reference lines 34 are straight lines extending in the lateral direction of the pixel region 32. The first reference lines 34 are located in parallel at every three pixel regions 32 in the longitudinal direction of the pixel region 32. Each of the first reference lines 34 is located at the center of each corresponding one of the pixel regions 32 in the longitudinal direction of the pixel region 32. The second reference lines 35 are straight lines extending in the longitudinal direction of the pixel region 32. The second reference lines 35 are provided on the green pixel regions 32g and are located in parallel at every three green regions 32g in the lateral direction of the pixel region 32. Each of the second reference lines 35 is located at the center of each corresponding one of the green pixel regions 32g in the lateral direction of the green pixel region 32g. The first reference lines 34 and the second reference lines 35 define the lattice on the color filter 30.

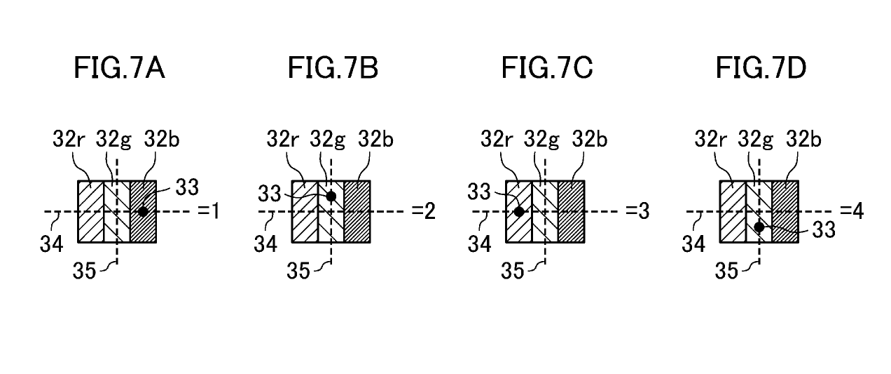

Each of the dots 33 is located near the intersection point of the corresponding one of the first reference lines 34 and the corresponding one of the second reference lines 35. FIGS. 7A-7D are views illustrating location patterns of the dots 33. The dot 33 is located at a location shifted from the intersection point in any one of four orthogonal directions (upward, downward, to the left, and to the right in FIG. 6 and FIGS. 7A-7D). Specifically, the location of the dot 33 is any of the locations illustrated in FIGS. 7A-7D. In the location of FIG. 7A, the dot 33 is located at a location shifted from the intersection point of the first reference line 34 and the second reference line 35 to the right on the first reference line 34. Here, the dot 33 is located on the blue pixel region 32b. The digitized representation of this location is “1.” In the location of FIG. 7B, the dot 33 is located in a location shifted from the intersection point of the first reference line 34 and the second reference line 35 upward on the second reference line 35. Here, the dot 33 is located on the green pixel region 32g. The digitized representation of this location is “2.” In the location of FIG. 7C, the dot 33 is located at a location shifted from the intersection point of the first reference line 34 and the second reference line 35 to the left on the first reference line 34. Here, the dot 33 is located on the red pixel region 32r. The digitized representation of this location is “3.” In the location of FIG. 7D, the dot 33 is located at a location shifted from the intersection point of the first reference line 34 and the second reference line 35 downward on the second reference line 35. Here, the dot 33 is located on the green pixel region 32g. The digitized representation of this location is “4.” In any one of the locations, the amount of shift of the dot 33 from the intersection point of the first reference line 34 and the second reference line 35 is constant.

One unit area includes 6×6 dots, and 36 dots 33 included in one unit area form one dot pattern. The location of each of 36 dots 33 included in each unit area is arranged in any one of the locations of “1”-“4” described above, so that a large number of dot patterns can be formed. Each unit area has a different dot pattern. The dot pattern formed by the plurality of dots 33 is an example black pattern.

Information is added to each of the dot patterns. Specifically, a dot pattern shows the location coordinate for each unit area. That is, when the color filter 30 is divided into unit areas each including 6×6 dots, each dot pattern shows the location coordinate of the corresponding one of unit areas. As a method for such patterning (coding) of the dot patterns and performing coordinate transformation (decoding), for example, a known method as disclosed in Japanese Patent Publication No. 2006-141067 may be used.

### 5. Operation

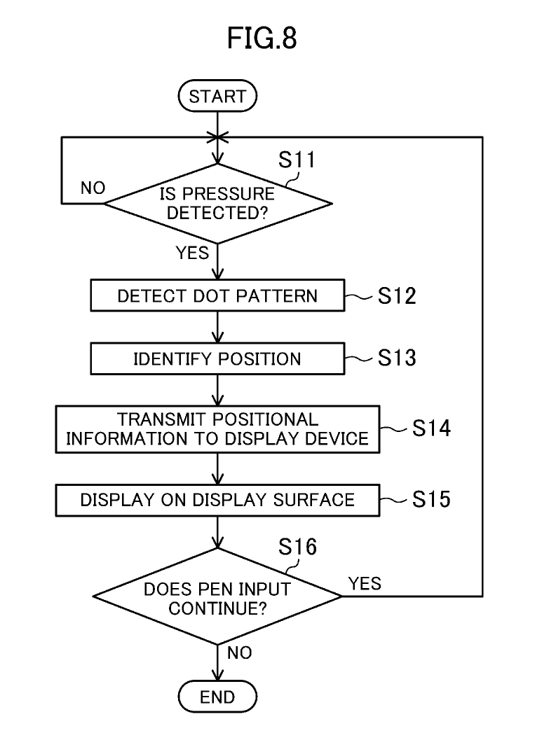

The operation of the display control system 100 configured as described above will be described. FIG. 8 is a flow chart illustrating a flow of processing performed by the display control system 100. An example where a user inputs a character to the display device 20 with the digital pen 10 will be described below.

First, when a power supply of the display control system 100 is turned on, in Step S11, the pen processor 16b of the digital pen 10 starts monitoring of pressure applied to the nib 12. The detection of the pressure is performed by the pressure sensor 13. When the pressure is detected (YES), the pen processor 16b determines that the user inputs a character to the display area 21 of the display device 20, and the process proceeds to Step S12. While the pressure is not detected (NO), the pen processor 16b repeats Step S11.

In Step S12, the reader 15 of the digital pen 10 detects a dot pattern formed in the display area 21. When the pressure is detected by the pressure sensor 13, infrared light is output from the optical source 14. A part of the infrared light is absorbed at least into the dots 33 provided in the color filter 30 of the display device 20, whereas the rest of the infrared light is reflected at the pixel regions 32, etc. The reflected infrared light enters the imaging device 15b via the objective lens 15a. The objective lens 15a is located so as to receive reflected light from a location indicated by the nib 12 on the display area 21. As a result, the dot pattern in the indicated location on the display area 21 is captured by the imaging device 15b. In this way, the reader 15 optically reads the dot pattern. The image signal obtained by the reader 15 is transmitted to the decoder 16a.

In Step S13, the decoder 16a obtains the dot pattern from the image signal and, based on the dot pattern, the decoder 16a determines the location of the nib 12 on the display area 21. Specifically, the decoder 16a performs predetermined image processing on the obtained image signal, thereby obtaining the dot pattern. For example, similar to the dots 33, the black matrix 31 is made of carbon black, and thus, absorbs the infrared light. Therefore, an image from the reader 15 includes the black matrix 31 in the same state as the state of the dots 33. Then, the decoder 16a performs predetermined image processing on the obtained image signal from the reader 15 to make it easier to determine the dots 33 from the black matrix 31, thereby obtaining the location of the dots 33, based on the processed image signal. Subsequently, the decoder 16a determines a unit area including 6×6 dots, based on the obtained location of the dots 33, and determines the location coordinate (locational information) of the unit area, based on the dot pattern of the unit area. The decoder 16a converts the dot pattern to a location coordinate by predetermined operation corresponding to the coding method of the dot pattern. The determined locational information is transmitted to the pen processor 16b.

Subsequently, in Step S14, the pen processor 16b transmits the locational information to the display device 20 via the transmitter 17.

The locational information transmitted from the digital pen 10 is received by the receiver 22 of the display device 20. The received locational information is transmitted from the receiver 22 to the display processor 23. In Step S15, upon receiving the locational information, the display processor 23 controls the display panel 24 so that display contents in a location corresponding to the locational information are changed. In the example, since a character is input, a point is displayed in the location corresponding to the locational information on the display area 21.

Subsequently, in Step S16, the pen processor 16b determines whether or not the input by the user continues. When the pressure sensor 13 detects the pressure, the pen processor 16b determines that the input by the user continues, and the process goes back to Step S11. The above-described flow is repeated, so that points are, in accordance with the movement of the nib 12 of the digital pen 10, continuously displayed in the locations of the nib 12 on the display area 21. Finally, a character in accordance with the trace of the nib 12 of the digital pen 10 is displayed on the display surface 21 of the display device 20.

On the other hand, in Step S16, when the pressure sensor 13 detects no pressure, the pen processor 16b determines that the input by the user does not continue, and the process is terminated.

In this way, the display device 20 displays, on the display area 21, the trace of the tip of the digital pen 10 on the display area 21, thereby enabling handwriting input to the display area 21 using the digital pen 10.

Note that, although the case of inputting a character has been described above, the use of the display control system 100 is not limited to the case described above. In addition to characters, digits, symbols, and drawings, etc. can be input. It is also possible to use the digital pen 10 as an eraser to erase characters, and drawings, etc. displayed in the display area 21. That is, the display device 20 continuously erases displays in the locations of the digital pen 10 on the display area 21 in accordance with the movement of the digital pen 10, thereby erasing displays in parts corresponding to the trace of the tip of the digital pen 10 on the display area 21. Furthermore, the digital pen 10 may be used as a mouse to move a cursor displayed on the display area 21 or to select an icon displayed on the display area 21. That is, a graphical user interface can be operated using the digital pen 10. As described above, in the display control system 100, the location on the display area 21 indicated by the digital pen 10 is input to the display device 20, and the display device 20 performs various display controls in accordance with the input.

### 6. Advantages of Embodiment

As described above, according to the present embodiment, the display control system 100 includes the display device 20 having the display area 21 in which the plurality of pixels 40 is provided and which displays an image, and the digital pen 10 configured to indicate a location on the display area 21, and performs display control in accordance with the location indicated by the digital pen 10. A locational information pattern that indicates the location on the display area 21 is provided on the display area 21, the digital pen 10 is configured to optically read the locational information pattern in the location indicated on the display area 21, and the display device 20 controls the display area 21 so that display contents in the location corresponding to the locational information pattern read by the digital pen 10 is changed. Each of the pixels 40 includes the red sub pixel 41r, the green sub pixel 41g, and the blue sub pixel 41b. The locational information pattern is provided in the sub pixels 41 and is formed by the plurality of dots 33 that absorb or reflect light. The digital pen 10 includes the optical source 14 configured to output light and the reader 15 configured to receive light output from the optical source 14 and reflected by the display area 21 and to thereby read the locational information pattern.

Also, the display device 20 includes the display area 21 in which the plurality of pixels 40 is provided and which displays an image. A locational information pattern that can be optically read from the outside and indicates a location on the display area 21. Each of the pixels 40 includes the red sub pixel 41r, the green sub pixel 41g, and the blue sub pixel 41b. The locational information pattern is provided in the sub pixels 41 and is formed by the dots 33 that absorb or reflect light.

Furthermore, the display panel 24 includes the display area 21 in which the plurality of pixels 40 is provided and which displays an image. A locational information pattern that can be optically read from the outside and indicates a location on the display area 21.

In the above-described configuration, the location of the digital pen 10 is detected by reading the locational information pattern on the display area 21, thereby enabling high definition handwriting input. That is, another possible configuration which enables handwriting input on a display surface of a display device is a configuration in which a sensor, such as an electrostatic capacitance sensor, etc., is built in the display device, a contact point of a stylus on a display surface is detected by the sensor to detect the location of the stylus, and thus, perform input in accordance with the trace of the stylus. In such a configuration, the degree of definition of handwriting input depends on the accuracy of detection of the location of the stylus, that is, location detection resolution of the sensor. However, the sensor has a certain size, and it is difficult to provide many sensors in the display device. Also, as the number of touch sensors increases, the cost increases. In contrast, according to this embodiment, the degree of definition of the handwriting input depends on the accuracy of the detection of a dot pattern by the digital pen 10. The detection accuracy can be increased in a simple manner by increasing the density of the dot pattern. To what degree the density of the dot pattern can be increased depends on not only the capability of dot pattern production at high density but also the resolution of the digital pen 10 and the capability of dot pattern determination. However, it is easier to produce a dot pattern at high density than to increase the detection resolution of a touch sensor. Also, even when the resolution of the digital pen 10 is not increased to a very high level, a high-density dot pattern can be read sufficiently enough, as compared to the case where the detection resolution of a touch sensor is increased. Therefore, as compared to the configuration in which the location of a pen is detected by a sensor of a display device, high definition handwriting input can be performed by reading the dot pattern on the display area 21 to detect the location of the digital pen 10.

Also, the display area 21 includes the black matrix 31 and the pixel regions 32 which are defined by the black matrix 31, the locational information pattern is formed by the plurality of dots 3, and the dots 33 are made of the same material as that of the black matrix 31.

In the above-described configuration, production of the display panel 24 can be simplified, and furthermore, production of the display device 20 can be also simplified. That is, the black matrix 31 and the dots 33 are made of the same material, and thus, the number of materials used when the display panel 24 is produced can be reduced. In addition, since the black matrix 31 and the dots 33 are made of the same material, the black matrix 31 and the dots 33 can be formed in common process steps.

Since the dots 33 are provided in the pixel regions 32, the black matrix 31 and the dots 33 can be easily distinguished from each other even when the black matrix 31 and the dots 33 are made of the same material.

The digital pen 10 includes the optical source 14 configured to output light and the reader 15 configured to receive light output from the optical source 14 and reflected by the display area 21 and to thereby read the locational information pattern.

In this configuration, even when, in a dark environment, the digital pen 10 includes a light source, and thus, the locational information pattern can be optically read with high accuracy.

The digital pen 10 includes the decoder 16a configured to determine, based on the read locational information, a location on the display area 21 in which the locational information pattern is provided.

In this configuration, the digital pen 10 determines a location indicated by the digital pen 10, and thus, processing of the display device 20 can be simplified.

### 7. Modified Examples

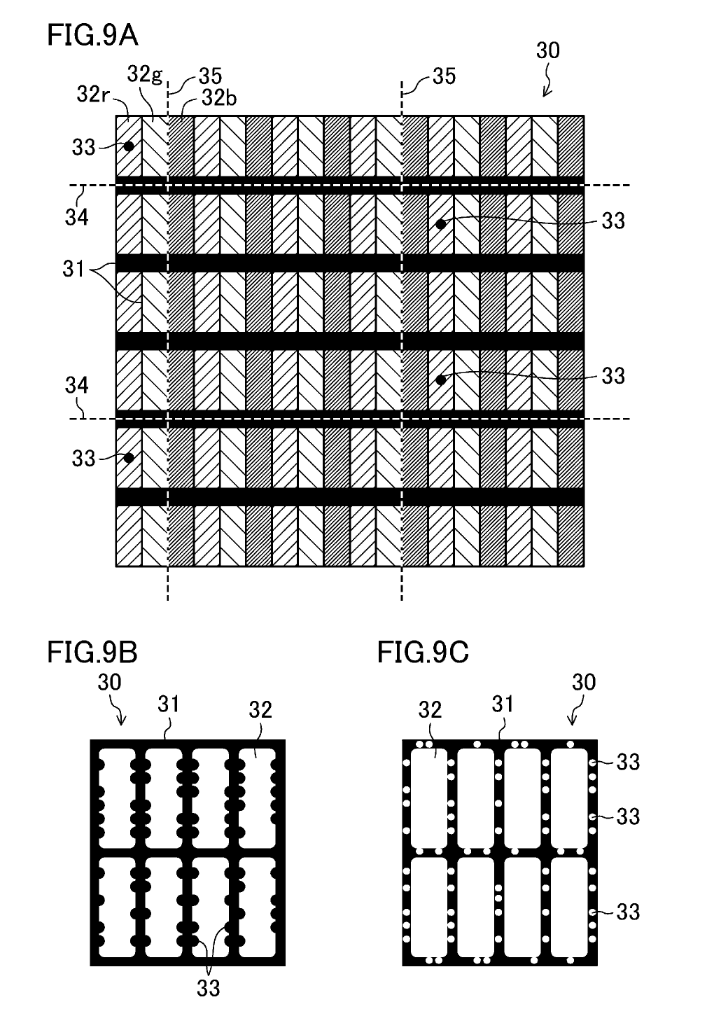

Modified examples of a dot pattern will be described below. Each of FIGS. 9A-9C illustrates a dot pattern according to a modified example.

In the dot pattern illustrated in FIG. 9A, each of the dots 33 is located at a location shifted in an oblique direction from the intersection point of the corresponding one of the first reference lines 34 and the corresponding one of the second reference lines 35. That is, the dot 33 is located in a location shifted from the intersection point of the first reference line 34 and the second reference line 35 in an upper left direction, an upper right direction, a lower left direction, or a lower right direction. Note that, in this modified example, the first and second reference lines 34 and 35 are provided on the black matrix 31.

In the dot pattern illustrated in FIG. 9B, the width of the dots 33 is larger than the width of lines forming the black matrix 31, and the dots 33 are located on the black matrix 31. Specifically, each of the dots 33 is located on the corresponding one of the lines of the black matrix 31 but protrudes from the line.

As described above, the dots 33 are located on the lines of the black matrix 31 and have a larger width than that of the lines of the black matrix 31. In this configuration, as compared to the configuration in which the dots 33 are located on the pixel regions 32, the influence of the dots 33 on the pixel regions 32 can be reduced.

In the dot pattern illustrated in FIG. 9C, the dots 33 are located on the black matrix 31 but have a different infrared light reflectance from that of the black matrix 31. Specifically, white blanks are formed as the dots 33 on the lines of the black matrix 31.

As described above, the dots 33 are formed on the black matrix 31 such that parts of the black matrix 31 are removed. In this configuration, as compared to the configuration in which the dots 33 are located on the pixel regions 32, the influence of the dots 33 on the pixel regions 32 can be reduced.

Note that, in the modified examples of FIGS. 9B and 9C, an interval between adjacent ones of the dots 33 in the column and lateral row of the drawings is equal to or smaller than an interval of adjacent ones of the first reference lines 34 and an interval of adjacent ones of the second reference lines 35.

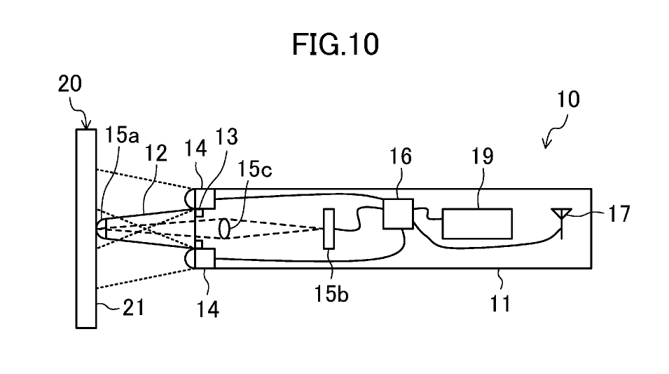

Next, a modified example of the digital pen 10 will be described. FIG. 10 is a cross-sectional view schematically illustrating a configuration of the digital pen 10 according to another modified example.

In the digital pen 10 according to the modified example, the nib 12 is made of a material which is transmissive to infrared light. The objective lens 15a is built in the tip of the nib 12. The reader 15 further includes a lens 15c. The objective lens 15a and the lens 15c form an optical system. A plurality of optical source s 14 (for example, four optical sources 14) are located at the tip of the body 11 so as to surround the nib 12. The number of the optical sources 14 can be set, as appropriate. Also, the optical source 14 may be formed into a ring shape.

That is, the digital pen 10 has a pen shape including the nib 12, and the reader 15 includes the imaging device 15b and the objective lens 15a provided in the nib 12 and configured to form an image on the imaging device 15b from light reflected by the display area 21.

According to this modified example, the contact point of the digital pen 10 and the display area 21 corresponds to a part in which a dot pattern is read, and thus, the location of the tip of the nib 12 can be more accurately detected. As a result, a user can realize handwriting using the digital pen 10 such that the user has a feeling close to that of actually writing using a pen.

### Second Embodiment

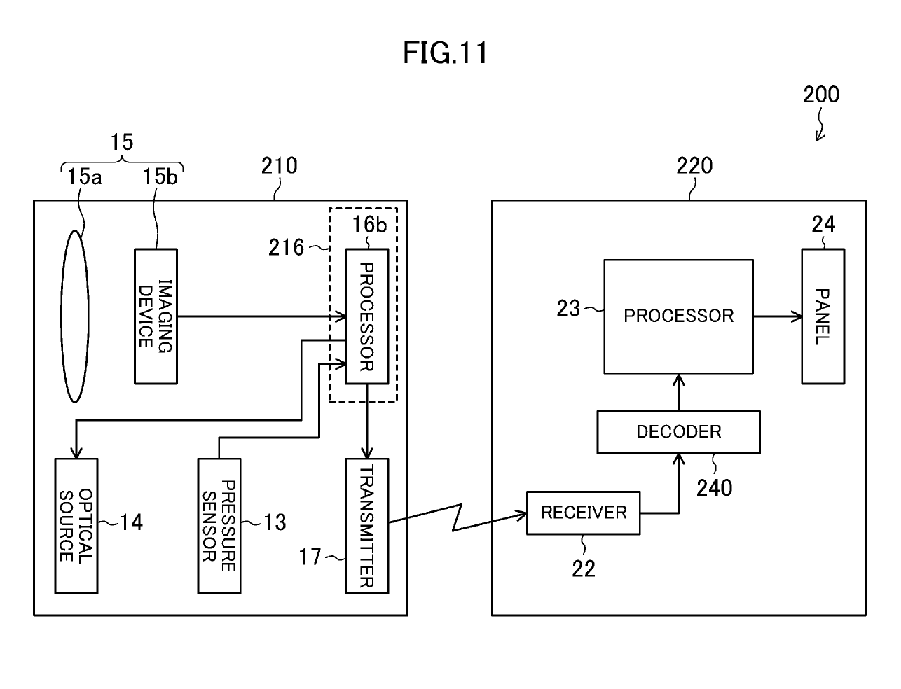

Next, a display control system 200 according to a second embodiment will be described. FIG. 11 is a block diagram schematically illustrating a configuration of the display control system 200. The display control system 200 is configured such that the location of a digital pen 210 is specified by not the digital pen 210 but a display device 220, and in this point, the second embodiment is different from the first embodiment. Each part having a similar configuration to that of the corresponding part in the first embodiment is identified by the same reference character, and the following description is given with focus on parts different from the first embodiment.

As illustrated in FIG. 11, the digital pen 210 includes the pressure sensor 13, the optical source 14, the reader 15, the controller 216, and the transmitter 17. The configurations of pressure sensor 13, the optical source 14, the reader 15, and the transmitter 17 are similar to those of the first embodiment. The controller 216 includes the pen processor 16b but does not include the decoder 16a of the first embodiment. That is, the controller 216 outputs an image signal input from the imaging device 15b to the transmitter 17 without determining the locational information of the digital pen 210, based on the image signal. An image signal captured by the imaging device 15b is thus transmitted from the digital pen 210.

As illustrated in FIG. 11, the display device 220 includes the receiver 22 configured to receive a signal from the outside, the display processor 23 configured to control the entire display device 220, the display panel 24 configured to display an image, and a decoder 240 configured to determine the location of the digital pen 10. The configurations of the receiver 22, the display processor 23, and the display panel 24 are similar to those of the first embodiment. The dot pattern illustrated in FIG. 4 is formed on the display area 21 of the display panel 24. The receiver 22 receives a signal transmitted from the digital pen 210 and transmits the signal to the decoder 240. The decoder 240 has a similar function to that of the decoder 16a of the digital pen 10 in the first embodiment. That is, according to this embodiment, a signal transmitted from the digital pen 210 is an image signal obtained by the imaging device 15b, and therefore, the decoder 240 determines the location of the digital pen 210, based on the image signal. That is, similar to the decoder 16a, the decoder 240 obtains a dot pattern from an image signal, and determines the location coordinate of the nib 12 on the display area 21, based on the dot pattern. The decoder 240 transmits determined locational information to the display processor 23. The display processor 23 controls the display panel 24 such that display information displayed on the display area 21 is changed, based on the locational information.

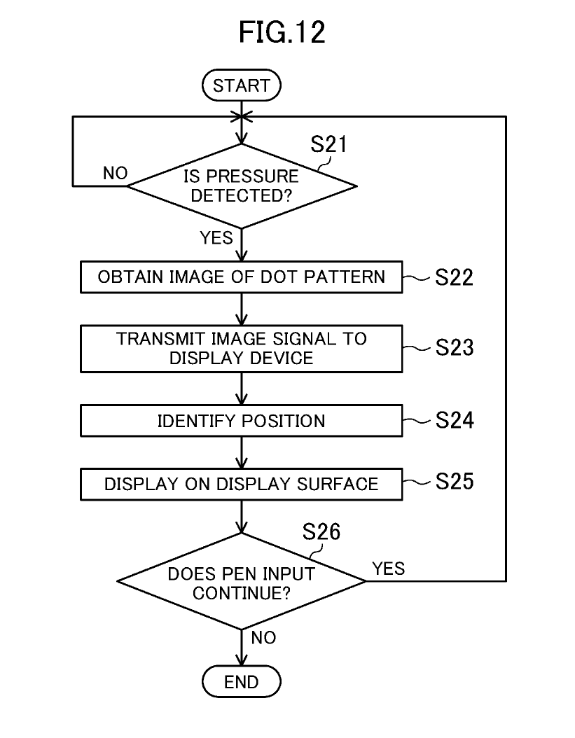

Next, the operation of the display control system 200 will be described. FIG. 12 is a flow chart illustrating a flow of processing performed by the display control system 200. An example where a user inputs a character to the display device 220 with the digital pen 210 will be described below.

When a power supply of the display control system 200 is turned on, in Step S21, the pen processor 16b of the digital pen 210 monitors whether or not a pressure is applied to the nib 12. When the pressure is detected (YES), the pen processor 16b determines that the user inputs a character to the display area 21 of the display device 220, and the process proceeds to Step S22. In Step S22, the reader 15 of the digital pen 210 obtains an image of a dot pattern formed on the display area 21. An image signal obtained by the reader 15 is transmitted to the display device 220 via the transmitter 17 in Step S23.

An image signal transmitted from the digital pen 210 is received by the receiver 22 of the display device 220 in Step S24. The received image signal is transmitted to the decoder 240. The decoder 240 obtains a dot pattern, based on the image signal, and determines the location of the digital pen 210. Locational information determined by the decoder 240 is transmitted to the display processor 23.

Subsequently, in Step S25, upon receiving the locational information, the display processor 23 controls the display panel 24 such that display contents in a location corresponding to the locational information is changed. In the example, since a character is input, a point is displayed in the location corresponding to the locational information on the display area 21.

Thereafter, in Step S26, the pen processor 16b determines whether or not the input by the user continues. If the input continues (YES), the process goes back to Step S11, and the above-described flow is repeated. On the other hand, if the input does not continue, the process is terminated. In this way, a character in accordance with a trace of the nib 12 of the digital pen 210 is displayed on the display area 21 of the display device 220.

The above-described processing is performed, and thus, the display control system 200 can detect the location of the digital pen 210 operated by the user in a high definition manners and reflect the location to the display area 21 in a high definition manner.

Accordingly, the display device 220 further includes the decoder 240 configured to determine, based on the locational information read by the digital pen 210, a location on the display area 21 in which the locational pattern is provided.

In this configuration, the display device 220 determines a location indicated by the digital pen 210, and thus, the processing of the digital pen 210 can be simplified.

### OTHER EMBODIMENTS

As described above, embodiments have been described as examples of the technology disclosed in the present application. However, the technology according to the present disclosure is not limited thereto but is applicable to embodiments with appropriate modification, replacement, addition, and omission, etc. Moreover, it is also possible to form a new embodiment by combining constituent elements described in the above first and second embodiments.

Other embodiments will be describes below.

In each of the above-described embodiments, a liquid crystal display has been described as an example of the display device, but the display device is not limited thereto. The display device 20 and 220 may be a device, such as a plasma display, an organic EL display, or an inorganic EL display, etc., which can display a character and an image. Also, the display device 20 and 220 may be a device, such as an electronic paper, a display surface of which can be freely deformed.

The display device 20 and 220 may be a notebook PC or a display of a mobile tablet. Furthermore, the display device 20 and 220 may be a TV or an electronic black board, etc.

A switching section configured to switch an input mode from one to another may be provided in the digital pen 10 and 210 or the display device 20 and 220. Specifically, a switch may be provided in the digital pen 10 and 210 to switch the mode from one to another among input of a character, etc., erasing of a character, etc., moving of a cursor, and selecting of an icon, etc. As another option, the display device 20 and 220 may be configured to display icons used for switching the mode from one to another among input of a character, etc., erasing of a character, etc., moving of a cursor, and selecting of an icon, etc., and to select one of the icons using the digital pen 10 and 210, respectively. Furthermore, a switch corresponding to a right click or a left click of a mouse may be provided to the digital pen 10 and the 210 or the display device 20 and 220. Thus, operability can be further increased.

Transmission and reception of a signal between the digital pen 10 and 210 and the display device 20 and 220 are performed via wireless communication, but are not limited thereto. The digital pen 10 and 220 may be connected to the display device 20 and 220, respectively, via a wire so that transmission and reception of a signal is performed via the wire.

According to the first embodiment, the digital pen 10 performs the processing up to determination of the locational information and transmits the locational information to the display device 20. According to the second embodiment, the digital pen 210 obtains an image signal of a dot pattern and transmits the image signal to the display device 220. However, the processing performed in a display control system according to the present disclosure is not limited thereto. For example, in the digital pen 10 and 210, after an image of a dot pattern is obtained, the process up to image processing may be performed to reduce the amount of date, and then, a processed signal may be transmitted to the display device 20 and 220. That is, as long as the digital pen 10 and 210 obtains information relating to a location indicated by the digital pen 10 and 210 on the display area 21, the information relating to the location is transmitted from the digital pen 10 and 210 to the display device 20 and 220, respectively, and the display device 20 and 220 performs various display controls in accordance with the information relating to the location, any information may be used as the information relating to the location.

In each of the first and second embodiments, the decoder configured to determine the location of the digital pen 10 on the display area 21 is provided on the digital pen 10 or the display device 220, but the decoder is not limited thereto, but the decoder may be provided as an individual control unit separated from the digital pen 10 and the display device 220. For example, a display control system in which a digital pen is added to a desktop PC including a display device (an example of the display device) and a PC body (an example of the controller) may be configured such that, in the display control system, a dot pattern is provided on a display area of the display device, the digital pen optically reads the dot pattern and transmits the dot pattern to the PC body, the PC body determines the location of the digital pen, based on the dot pattern, and orders the display device to perform processing in accordance with the determined location.

In the above-described embodiments, the pressure sensor 13 is used only to determine whether or not pressure is applied, but is not limited thereto. For example, the magnitude of pressure may be detected based on a detection result of the pressure sensor 13. Thus, continuous changes in pressure can be read. As a result, the width and thickness of a displayed line can be changed based on the magnitude of pressure.

Note that, in the above-described embodiments, using the pressure sensor 13, whether or not input using the digital pens 10 and 210 is detected, but the detection of an input is not limited thereto. A switch configured to switch between on and off of input may be provided to the digital pen 10 and 210 so that, when the switch is turned on, it is determined that an input is made. In this case, even when the digital pen 10 and 210 does not contact a surface of the display area 21, an input can be made. As another option, the display device 20 and 220 may be configured such that a surface of the display area 21 is caused to oscillate at a certain frequency and a change in the frequency due to contact of the display device 20 and 220 to the surface of the display area 21 is detected by the display device 20 and 220 to detect an input.

In the above-described embodiments, each of the pixel regions 32 has a rectangular shape, but is not limited thereto. The shape of each of the pixel regions 32 may be a triangle or a parallelogram, etc., or a shape obtained by combining those shapes. The shape of each of the pixel regions 32 may be a shape with which the display device can output a character or an image. The black matrix 31 may be changed as appropriate in accordance with the shape of each of the pixel regions 32.

Each of the dots 33 has a circular shape, but is not limited thereto. The shape of each of the dots 33 may be a polygonal shape, such as a triangle and a quadrangle, etc., or a shape, such as an ellipse.

The first and second reference lines 34 and 35 used for arranging the dots 33 are not limited to the above-described embodiments. For example, the first reference lines 34 are located at every three pixel regions 32 in the longitudinal direction of the pixel region 32, but may be located in each pixel region 32 in the longitudinal direction of the pixel region 32, or in every two pixel regions 32 or every four or more pixel regions 32 in the longitudinal direction of the pixel region 32. The second reference lines 35 are provided on the green pixel regions 32g or the black matrix 31, but are not limited thereto. For example, the second reference lines 35 may be provided on the red pixel regions 32r or the blue pixel regions 32b. The second reference lines 35 do not have to be provided on the pixel regions 32 of a specific signal color. The second reference lines 35 may be provided on the red pixel regions 32r, the green pixel regions 32g, and the blue pixel regions 32b in a mixed manner. Furthermore, how many pixel regions 32 are provided between adjacent ones of the second reference lines 35 is not limited to the above-described embodiment.

In the above-described embodiments, a dot pattern is formed in a unit area of 6×6, but is not limited thereto. The number of dots forming a unit area can be set as appropriate in accordance with the designs of the digital pen 10, the digital pen 210, the display device 20, and the display device 220. The configuration of a dot pattern is not limited to a combination of locations of dots included in a predetermined area. As long as a dot pattern can indicate specific locational information, a method of patterning is not limited to the above-described embodiments.

In the above-described embodiments, the locational information pattern is made of dots, but a mark is not limited to a dot. Instead of dots, the locational information pattern may be formed by marks represented by a diagram, such as a triangle and a quadrangle, etc., a character, such as an alphabet, etc. For example, a mark may be formed by filling an entire part of a pixel region 32.

Furthermore, the locational information pattern may be represented by a display on the display area 21.

The dots 33 are provided in the color filter 30, but are not limited thereto. The dots 33 may be provided in the glass substrates 25 or the polarizing filter 26.

As another option, the dots 33 can be represented by the pixels 40 of the display panel 24. That is, some of the plurality of pixels 40 included in the display area 21 can be used for the locational information pattern to control display of one of the pixels 40 or one of the sub pixels 41 in a location corresponding to any of “1”-“4” (for example, the corresponding pixel 40 is displayed as a dot of a specific color, such as black, etc.), thereby displaying the locational information pattern in the display area 21. Thus, a configuration in which the dots 33 are provided on the display area 21 can be realized. That is, the display device 20 displays the locational information pattern in the display area 21. In this configuration, the above-described display control system 100 can be realized without adding a particular improvement to a known display device 20.

The dots 33 are made of the same material as that of the black matrix 31, but are not limited thereto. For example, the dots 33 may be made of a material which reflects infrared light.

The decoder 16a converts a dot pattern to a location coordinate by operation, but is not limited thereto. For example, the decoder 16a may be configured to store all of dot patterns and location coordinates linked to the dot patterns, check an obtained dot pattern with relationships between the stored dot patterns and location coordinates, and determine a corresponding location coordinate.

As presented above, the embodiments have been described as examples of the technology according to the present disclosure. For this purpose, the accompanying drawings and the detailed description are provided.

Therefore, components in the accompanying drawings and the detailed description may include not only components essential for solving problems, but also components that are provided to illustrate the above-described technology and are not essential for solving problems. Therefore, such inessential components should not be readily construed as being essential based on the fact that such inessential components are shown in the accompanying drawings or mentioned in the detailed description.

Furthermore, the above-described embodiments have been described to exemplify the technology according to the present disclosure, and therefore, various modifications, replacements, additions, and omissions may be made within the scope of the claims and the scope of the equivalents thereof.

As described above, the technology disclosed herein is useful for a display control system including a display device and an instruction device.

What is claimed is:

1. A display control system, comprising:
a display device including a display area in which a plurality of pixels is provided and which displays an image; and
a pointer device configured to indicate a location on the display area,
wherein
the display control system performs display control in accordance with the location indicated by the pointer device,
each of the pixels includes a red sub pixel, a green sub pixel, and a blue sub pixel,
a locational information pattern indicating the location on the display area is provided on the display area,
the locational information pattern is made of a plurality of marks which is provided in the sub pixels and absorbs or reflects light,
the pointer device includes an optical source configured to output light and a reader configured to receive light output from the optical source and reflected by the display area and thereby read the locational information pattern and is configured to optically read the locational information pattern in a location indicated on the display area, and
the display device controls the display area such that display contents in a location corresponding to the locational information pattern read by the pointer device is changed.

2. The display control system of claim 1, wherein
the display area includes a black matrix configured to define the pixels, and
the marks are made of a same material as that of the black matrix.

3. The display control system of claim 1, wherein
each of the marks located at one of predetermined locations relative to virtual lines,
the locational information pattern is defined by a group of the marks, and represents the location on the display area by a combination of the locations of the group of marks, and
each of the virtual lines extends on corresponding ones of the green sub pixels.

4. The display control system of claim 1, wherein
the display area includes a black matrix configured to define the pixels, and
the marks are formed on the black matrix such that parts of the black matrix are removed.

5. The display control system of claim 1, wherein
the pointer device has a pen shape having a nib, and
the reader includes an imaging device and an objective lens provided in the nib and configured to form an image on the imaging device from light reflected by the display area.

6. The display control system of claim 1, wherein
the display device further includes a decoder configured to determine, based on the locational information pattern read by the pointer device, a location on the display area on which the locational information pattern is provided.

7. The display control system of claim 1, wherein
the pointer device further includes a decoder configured to determine, based on the locational information pattern read by the pointer device, a location on the display area on which the locational information pattern is provided.

8. A display device, comprising:
a display area in which a plurality of pixels is provided and which displays an image,
wherein
each of the pixels includes a red sub pixel, a green sub pixel, and a blue sub pixel,
a locational information pattern which is configured to be optically read from outside and indicates a location on the display area is provided on the display area, and
the locational information pattern is made of a plurality of marks which is provided in the sub pixels and absorbs or reflects light.

9. The display device of claim 8, wherein
the display area includes a black matrix and a colored layer defined by the black matrix,
the locational information pattern is made of a plurality of marks, and
the marks are made of a same material as that of the black matrix.

10. The display device of claim 8, wherein
each of the marks located at one of predetermined locations relative to virtual lines,
the locational information pattern is defined by a group of the marks, and represents the location on the display area by a combination of the locations of the group of the marks, and
each of the virtual lines extends on corresponding ones of the green sub pixels.

11. The display device of claim 8, wherein
the display area includes a black matrix configured to define the pixels, and
the marks are formed on the black matrix such that parts of the black matrix are removed.
